(19) United States
(12) Patent Application Publication
(10) Pub. No.: US 2018/0144280 A1
(43) Pub. Date: May 24, 2018

(54) SYSTEM AND METHOD FOR ANALYZING THE FOCUS OF A PERSON ENGAGED IN A TASK

(71) Applicant: INTERNATIONAL BUSINESS MACHINES CORPORATION, Armonk, NY (US)

(72) Inventors: Michael Bender, Rye Brook, NY (US); Gregory J. Boss, Saginaw, MI (US); Edward T. Childress, Austin, TX (US); Rhonda L. Childress, Austin, TX (US)

(21) Appl. No.: 15/358,254

(22) Filed: Nov. 22, 2016

(51) Int. Cl. G06Q 10/06; G06F 11/34; G06F 11/30

(52) U.S. Cl. CPC G06Q 10/06398; G06F 11/3024; G06F 11/3438

(57) ABSTRACT

A method and system analyzes the focus of a person engaged in a task. A computing device receives configuration data from sensors including focus parameters and environmental parameters related to a corresponding attention score of the person engaged in the task. The focus and environmental parameter data is analyzed to determine any impact on the person's focus during the task. Changes in the focus parameters, the environmental parameters and the attention score are stored in the computing device, and optimum values are determined.

### TECHNICAL FIELD

The invention relates to measuring and analyzing outside influences which affect the focus of a person engaged in a task.

### BACKGROUND

Prior art systems and methods to measure and adjust the focus of a person engaged in a task fail to accurately measure and account for numerous environmental factors which vary for each individual. Accordingly, such systems and methods have a low probability of successfully assessing the focus of a specific person engaged in a specific task.

### SUMMARY

The present invention provides a method, and associated computer system and computer program product, for analyzing focus of a person engaged in a task. The method includes the steps of: A) receiving, by a computing device, configuration data including identification of a task, baseline measurements of focus parameters related to a corresponding attention score of the person engaged in the task, and baseline measurements of environmental parameters of the environment where the person is performing the task; (B) receiving from focus sensors and analyzing, by the computing device, focus parameter data captured by the focus sensors to measure and monitor the focus parameters of the person engaged in the task; (C) receiving from environmental sensors and analyzing, by the computing device, environmental parameter data captured by the environmental sensors to measure and monitor the environmental parameters impacting the person engaged in the task; (D) detecting, by the computing device in response to a change in the focus parameter data received from the focus sensors, cognitive degradation of the person engaged in the task and, in response, lowering the attention score and storing in the computing device the lowered attention score, the changed focus parameter data and corresponding environmental parameter data; (E) detecting, by the computing device in response to a change in the focus parameter data received from the focus sensors, cognitive elevation of the person engaged in the task and, in response, elevating the attention score and storing in the computing device the elevated attention score, the changed focus parameter data and corresponding environmental parameter data; and (F) repeating steps (B) through (E) until receiving, by the computing device, a task pause or task completion signal.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIGS. 1A, 1B and 1C together form a flowchart diagram of a method of analyzing outside influences which affect the focus of a person engaged in a task in accordance with embodiments of the present invention.

FIG. 2A is a detailed flowchart diagram of step 118 of FIG. 1B in accordance with embodiments of the present invention.

FIG. 2B is a detailed flowchart diagram of step 126 of FIG. 1B in accordance with embodiments of the present invention.

FIG. 3 is a block diagram of a computer system for analyzing outside influences which affect the focus of a person engaged in a task in accordance with embodiments of the present invention.

### DETAILED DESCRIPTION

In the following description, specific details are set forth although it should be appreciated by one of ordinary skill that the present invention can be practiced without at least some of the details. In some instances, known features or processes are not described in detail so as not to obscure the present invention.

The present invention relates to a method and system for measuring and analyzing outside influences which affect the focus and attention of a person engaged in a task, and in turn, communicating the effects of these outside influences so that adjustments can be made to provide an optimal work environment for heightened focus of the person engaged in the specific task.

Many factors affect the focus of a person engaged in a task. Different people are distracted by different outside influences depending in part on the task at hand and often an individual will not recognize that environmental factors are degrading his or her ability to perform and complete a task. It would therefore be beneficial if a system and method could be provided to aid a user, e.g. the person performing the task, in tracking environmental factors and suggesting changes with regards to one or more of the environmental factors to promote alertness and focus, or to otherwise increase the ability of the person to be more focused while engaged in the task.

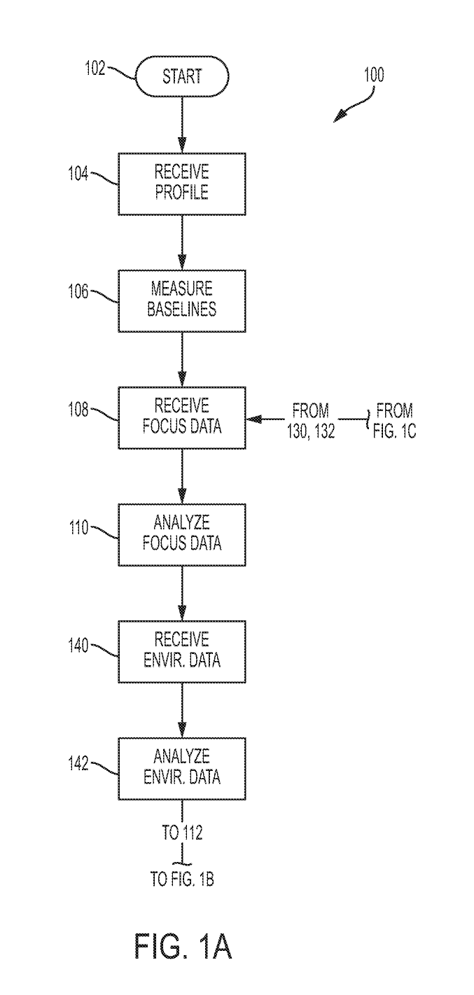

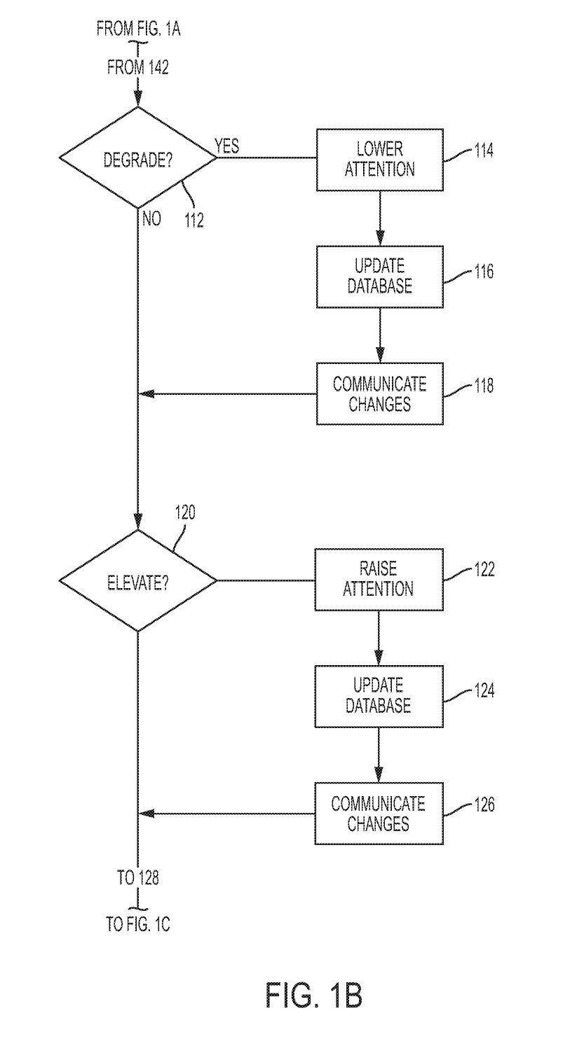

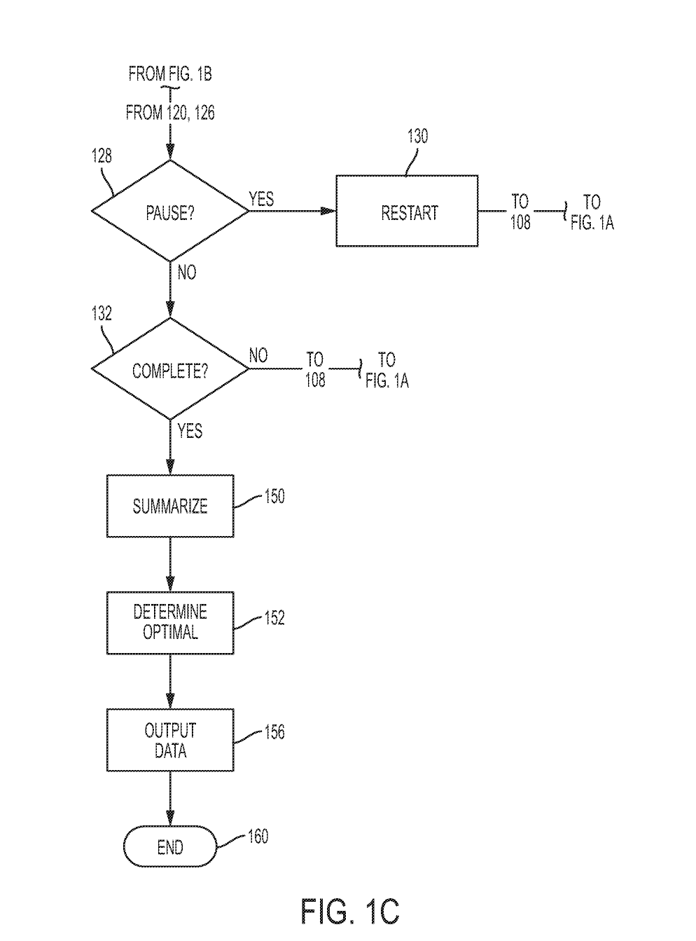

FIGS. 1A, 1B and 1C together form a flowchart diagram of a method of analyzing outside influences which affect the focus of a person engaged in a task in accordance with embodiments of the present invention.

Upon starting a task in step 102, configuration data aka profile data is immediately received and placed into a configuration file in step 104 by a computing device. The configuration data can include initial data whereby the person is embarking upon the task for the first time, or it can be configuration data that has been previously entered and stored whereby the task has been previously performed by the same individual. The configuration data can be received, for instance, from a database or from a user input device connected to the computing device. The computing device can be any kind of computing device with networking capability such as a computer, tablet or smart phone and the user input device can be, for example, a keyboard, touchscreen or mouse.

Configuration data in one example includes personal data of the person performing the task such as his name, age, height, weight, educational level, special skills related to the task at hand, training and experience. The configuration data would also include identification of the task at hand, including typical completion time and requirements for completing the task, as determined from previously accumulated and stored data, or from an estimation.

Typically when a task starts in step 102, the user would enter the configuration data and time in step 104, and he would identify the task. The user, who can be the individual or person performing the task, would enter or select which focus parameters and environmental parameters as part of the configuration data. These parameters would be monitored during execution of the task. The user can also be a person other than the person performing the task, for instance, a system administrator.

In the current example the task is identified as creating a slide presentation summarizing a group a marketing proposals for a marketing program to be launched to include television and radio ads for promoting a new product line of clothing going on sale soon in a chain of retail stores. The person responsible for completion of the task is the project manager who is a 35 year old female with a marketing degree from a local university and 10 years of experience in the field of retail marketing. The computing device for collecting, maintaining, monitoring and analyzing data with regards to the task is the project manager's desktop computer located in her work office. She has data processing skills which includes word processing, spreadsheets and graphical user programs. She has no special needs or requirements. Although the project manager has been involved in many marketing projects over the years, nothing similar to this particular task has been done by the project manager or anyone else at her marketing firm. In order to complete this task, the project manager must spend an estimated 8 hours on her desktop computer to read all the appropriate proposals, and then to summarize and organize them into a spreadsheet for the slide presentation.

During the initial configuration set-up in step 104, the project manager selects the focus parameters of (1) eye movement, and (2) physical body movements to be used as measurements of her attention span or focus during execution of the task. She also selects the environmental parameters to be measured as the ambient temperature and the noise level (i.e. sound level) in her office. Of course, these parameters could be selected automatically for this particular task or individual, or they could be input from any other source such as from another user/individual, e.g. a coworker or the project manager's boss. Different parameters could be selected if desired.

A list of focus parameters includes any parameter which is measurable and can be interpreted to relate to the focus/attention of the person engaged in the task. In addition to eye movements and body movements, focus parameters include, but are not limited to, facial expressions, head movements, body posture, blinking of eyes, closing of eyes, the number of pages turned of reading material opened on the computing device being used by the person engaged in the task, the number of applications opened on the computing device, etc.

In addition to ambient temperature and ambient sound/noise levels, a list of measurable environmental parameters includes, but is not limited to, ambient lighting, visual activity which could distract the user, smells, vibrations, air movement, chair comfort of the user, etc.

The project manager can input baseline values in step 106 to include a normal, .e.g. default, attention score along with both focus and environmental parameters into the configuration file, or she could defer to default values. In this example, she selected (1) an initial eye movement focus parameter value of 20 eye movements per minute with respect to reading on a desktop computer screen, (2) a norm of body movement focus parameter of 5 Body movements per minute, and (3) an attention score of 50 on a scale of 0-100. The attention score could be any measurable range such as 0-10, 0-100, etc. In the current example, an attention score of 0 indicates no attention whatsoever to the task at hand and an attention score of 100 indicates total attention to the task. The project manager selects the norm of 50 for the baseline attention score to be recorded in the configuration file.

Baseline values for the configuration data can be selected, automatically provided (e.g. from historical or statistical data), or directly measured in the environment where the person will complete the task. For instance in the current example the project manager has selected the environmental parameters to be the ambient temperature and the ambient noise/sound level in her office. She could select default values or perhaps more accurately have direct baseline measurements taken for the initial values as in step 106. For direct measurements for example, an air temperature thermometer could measure the air temperature at the starting time of the task and the air temperature data would be received from the digital thermometer as an input value into her computer and recorded as the baseline measurement of the environmental focus parameter. The baseline parameter for the ambient temperature in the project manager's office in this example is measured to be 68 degrees fahrenheit.

Similarly, a noise level detector could measure the noise/sound level in her office at the starting time of the task and the noise level reading could be received from the noise level detector as an input value into her computer and recorded as the baseline measurement of the noise level focus parameter. In this example the baseline parameter for the sound volume level in the project manager's office with her office door closed is given as 40±2 dB. This is the threshold for normal working hours with no extraneous noise present.

In step 108 the computing device (i.e. the project manager's desktop computer) receives both the eye movement focus parameter data and the body movement focus parameter data from the video of a built-in camera on the computing device during the project manager's execution of the task while she is reading text or otherwise engaged with the computer screen. Analysis of the measured/captured focus parameter data occurs in step 110. The analysis of both the eye movement and body movement focus parameter data includes monitoring the data with respect to time.

The computer also receives the environmental ambient sound parameter data and ambient temperature parameter data in step 140. This environmental parameter data is analyzed in step 142. The analysis of both the focus parameter data and the environmental parameter data includes generation of a time log of measurements so that changes of both the focus parameter data and the environmental parameter data can be tracked in relation to time.

Focus parameter data can be influenced by secondary applications (separate from the application being used for the task at hand) which are open and running on the user's computer, and that can create a distraction to the user and be a cause of lack of focus. These secondary applications can be any applications (e.g. social apps, email, computer games, music apps, news apps, stock market reports, etc.) running on the user's computer which are not needed to accomplish the task at hand.

Decision step 112 determines whether cognitive changes have been detected, with regards to the focus of the project manager during the execution of the task, that amounts to cognitive degradation of her focus or attention. This determination is based upon measurable changes in the focus parameter data. If no changes have occurred, or if the changes do not exceed a predetermined threshold, then the method continues on to decision step 120. For instance, if the number of eye movements captured by the computer camera is within a predetermined threshold of the initial value, i.e. 20±2, then no change is considered to have occurred in focus in view of the eye movement focus parameter. Similarly, if the number of body movements captured by the computer camera is within a predetermined threshold of the initial value, i.e. 5±1, then no change is considered to have occurred in focus in view of the body movement focus parameter. If focus degradation is detected beyond the acceptable thresholds as determined in step 112, then the current attention score is lowered in step 114.

Once the attention score is lowered, then a database, such as a memory area within the project manager's computer, is updated in step 116. In a preferred embodiment the change in the attention score and the temporally related focus and environmental parameters are communicated in step 118 to the project manager, for instance by a message or pop-up on the computer screen, or by a printout, alarm or other alert. Alternately, the change could be output from the computer and sent to another computing device such as, but not limited to, a mobile computing device, a smart phone or a computer in another location. Still yet, the changes could be logged into the database for future review without disturbing the project manager in real time during her engagement of the task.

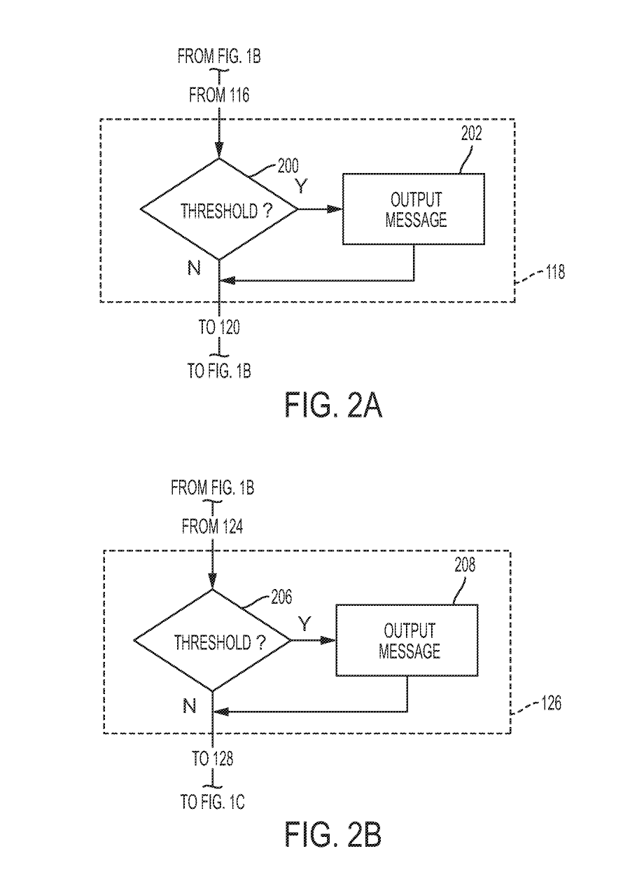

FIG. 2A is a detailed flowchart diagram of step 118 of FIG. 1B in accordance with embodiments of the present invention. Once the database in the computing device is updated in step 116 (see FIG. 1B) with an altered Attention score, then decision step 200 determines whether a predetermined threshold value/limit of the Attention score has been surpassed. If the threshold value has been passed, then step 202 outputs an alert such as a screen message, audio alert, or visual pop-up alarm to alert the user. When the threshold is met in step 200, i.e. threshold=YES, then the process outputs a message/alert in step 202. If the threshold is not been met, i.e. threshold=NO in step 200, then the process continues to step 120. In this way, the user can set up threshold values which are known to trigger a certain focus/attention response from the user. For instance, once the Attention score drops below a threshold value of, say 45, then the user may want to be aware of the change so that he can immediately remedy the situation, such as by adjusting the room temperature or taking a break. The process thereafter continues to step 120.

FIG. 2B is a detailed flowchart diagram of step 126 of FIG. 1B in accordance with embodiments of the present invention. Once the database in the computing device is updated in step 124 (see FIG. 1B) with a changed Attention score, then step 206 determines whether a predetermined threshold value of the Attention score has been surpassed. If the threshold value has been passed, then step 208 outputs an alert such as a screen message, audio alert, or visual pop-up alarm to alert the user. When the threshold is met in step 206, i.e. threshold=YES, then the process outputs a message/alert in step 208. If the threshold is not been met, i.e. threshold=NO in step 206, then the process continues to step 128. In this way, the user can set up threshold values which are known to trigger a certain focus/attention response from the user. The process thereafter continues to step 128.

In FIG. 1B, decision step 120 determines whether cognitive changes have been detected, with regards to the focus of the project manager during the execution of the task, that amounts to cognitive elevation of her focus. This determination is based upon measurable changes in the focus parameter data. If no changes have occurred, or if the changes do not exceed a predetermined threshold, then the method continues on to decision step 128. If focus elevation is detected beyond the thresholds as determined in step 120, then the current attention score is raised in step 122.

Once the attention score is elevated, then the computer database is updated in step 124. In a preferred embodiment the change in the attention score and the corresponding focus and environmental parameters are communicated in step 126 to the project manager, for instance by a message or pop-up on the computer screen, or by a printout, alarm or other alert. Alternately, the change could be output from the computer and sent to another computing device such as, but not limited to, a mobile computing device, a smart phone or a computer in another location. Still yet, the changes could be logged into the database for future review without disturbing the project manager in real time during her engagement of the task.

Step 128 determines whether a pause should occur in the engagement of the task. Pauses will occur from time to time, such as for a lunch break, a bathroom break, at the end of a work day, or any other interruption of the person engaged in the task. For instance, interruptions could occur from ringing telephones or knocks on the door of the project manager's office, etc.

The step 128 pause can be implemented in many different ways. For instance, the project manager could select to pause the task by clicking on an icon on the computer and at some later time, then selecting to resume the task. Pauses could also be programmed to occur at certain times or time intervals, whereby the computer will automatically pause the program being used for the task, for instance between noon and 1 pm each day.

If a pause is detected in decision step 128, then the process used with the task is paused in step 130 until either the project manager manually restarts the process by inputting a command to do so to the computer, or the process begins again at the end of a predetermined time period, such as after a 10 minute break. The need to restart the task could be signaled, for instance, by an audio alarm or a visual alert displayed on the computer screen, or upon recognition of the user re-entering into the field of view of the camera on the computing device after a break.

If no pause is detected in step 128, then the process continues on to decision step 132 where a determination is made whether the task is complete. If the task is not complete, then the process continues by returning to step 108 to receive additional focus parameter data. If the task has been completed, then a summary of all measured and stored data for the duration of the task is compiled in step 150. For instance the summary could include a listing of each measurement of each parameter at 30 second intervals, as well as average measurement values for each parameter including the attention score.

For the current example, Table I below shows sample data which is measured at 10 minute intervals between 9:00-11:00 am while the project manager (i.e. user) is engaged in the current task in her office. The initial profile values, representing the initial configuration data that was input by the user before starting the task, include: default values set by the user for the focus parameters of Eye Focus (eye movements) and Body Focus (body movements); default values set by the user for the environmental parameters of ambient room Temperature and Sound; and the default Attention score set by the user to 50 on a scale of 0-100 (100 being highest focus possible).

TABLE I

| Time | Eye Focus | Body Focus | Temp. | Sound | Attention |
|---|---|---|---|---|---|
| Initial profile | 20/min. ± 2 | 5/min. ± 1 | 68° F. | 40 dB | 50 |
| values | | | | | |
| 9:00am | 23 | 6 | 68° F. | 44 dB | 47 |
| 9:10 | 24 | 6 | 68 | 44 | 47 |
| 9:20 | 25 | 7 | 68 | 45 | 45 |
| 9:30 | 18 | 4 | 68 | 39 | 55 |
| 9:40 | 19 | 5 | 71 | 39 | 54 |
| 9:50 | 19 | 6 | 72 | 40 | 53 |
| 10:00am | 20 | 5 | 72 | 40 | 52 |
| 10:10 | 22 | 6 | 73 | 39 | 49 |
| 10:20 | 22 | 6 | 73 | 39 | 48 |
| 10:30 | 23 | 6 | 74 | 40 | 48 |
| 10:40 | 22 | 7 | 74 | 41 | 47 |
| 10:50 | 24 | 8 | 74 | 40 | 46 |
| 11:00am | 24 | 9 | 74 | 40 | 45 |

Correlation between the numerous variables and the project manager's Attention score is evident upon study of Table I. For instance, at 9:00 am there is a relatively high ambient sound level in the office of 44 dB which is +4 dB above the norm, with a maximum noise level of 45 dB occurring at 9:20 am. The room temperature is constant at 68° F. During this early period of heightened sound level the user's eye movements (which provide a measurement of the eye focus parameter), increase to an average of 25 movements per minute at 9:20 am which falls outside of the acceptable deviation of approximately ±2 eye movements per minute. During the same time frame, the body focus parameter increases to an average number of 7 body movements per minute, in contrast to the average default value of 5 body movements per minute. With these increases in the environmental parameters of Temperature and Sound, the commensurate Attention score decreases from the starting norm of 50 to a low of 45 at 9:20 am, signifying a noticeable decrease in attention or focus of the project manager to the task at hand. The lower Attention score of 45 corresponds to the changed Eye movement focus parameter data of 25, the changed Body movement focus parameter data of 7, the corresponding temperature environmental parameter data of 68° F., and the environmental noise level parameter of 45 dB.

At 9:30 am the temperature is measured as 70° F. and the excessive noise in the project manager's office subsides and is measured at the normal ambient sound level of 39 dB which is inconsequential in causing any variation in the user's attention or focus to the task, and the corresponding Attention score. In fact, the number of eye movements and body movements at 9:30 am of 18 and 4 respectively, are minimal for the measured time block of 9-11:00 am and the project manager's Attention score is maximized at 55. In this example, the elevated Attention score of 55 is the optimal Attention score for the designated time frame. The changed focus parameters are the corresponding Eye movement Focus parameter data of 18, the Body movement Focus parameter data of 4, the corresponding environmental Temperature parameter data of 68° F., and the corresponding environmental Sound level of 39 dB in the office.

Throughout the 2 hour period of 9-11:00 am the room temperature gradually rises from 68° F. at 9;00 am to 74° F. at 11:00 am. In response to the increasing room temperature, the focus parameters of Eye movements and Body movements indicate an increased user discomfort which causes a lack of focus. For instance, the number of body movements of the user has increased from an average of 6 per minute at 9:00 am to 9 per minute at 11:00 am. The average number of eye movements per minute has increased from 18 per minute at 9:30 am to 24 per minute at 10:50 am.

When the task, or some portion thereof, is completed, then the computing device in step 152 determines the measured data which yields the optimal Attention score which corresponds to the best conditions for attaining maximum focus or attention of the person engaged in the task. In this example the optimal elevated Attention score of 55 occurred at 9:30 am when the ambient Temperature in the project manager's office was 68° F. and the ambient Sound level was 39 dB.

Step 156 outputs a listing of all the measurement data, which in this case occurs at 10 minute intervals, and which includes the optimal conditions shown in Table I. The process ends in step 160.

All of the parameter data, the times and Attention scores are stored in a memory within the computing device with respect to the particular user, i.e. the project manager. Thus whenever the project manager again tackles this or a similar task, the stored data and particularly the measured ideal environmental conditions can be accessed and used as a starting point to replicate conditions that will maximize her attention and focus.

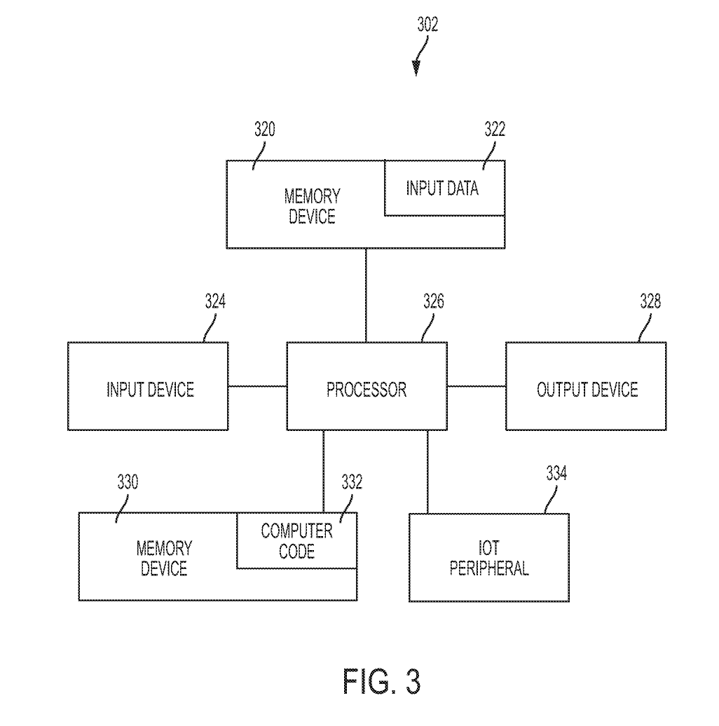

FIG. 3 is a block diagram of a computer system, aka computing device, 302 for analyzing the focus or attention of a person engaged in a task in accordance with embodiments of the present invention. The computing device 302 includes a processor 326, an input device 324 coupled to the processor 326, an output device 328 coupled to the processor 326, memory devices 320 and 330 each coupled to the processor 326, and one or more Internet of Things (IoT) peripheral devices 334 connected, or built-in, to the computing device 302. The input device 324 may be, inter alia, a keyboard, a mouse, etc. The output device 328 may be, inter alia, a printer, a plotter, a computer screen, a magnetic tape, a removable hard disk, a floppy disk, etc. The memory devices 320 and 330 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 330 includes a computer code 332 which is a computer program that includes computer-executable instructions. The computer code 332 includes software or program instructions that may implement an algorithm for implementing methods of the present invention. The processor 326 executes the computer code 332. The memory device 320 includes input data 322. The input data 322 includes input required by the computer code 332. The output device 328 displays output from the computer code 332. Either or both memory devices 320 and 330 (or one or more additional memory devices not shown) may be used as a computer usable storage medium (or program storage device) having a computer readable program embodied therein and/or having other data stored therein, wherein the computer readable program includes the computer code 332. Generally, a computer program product (or, alternatively, an article of manufacture) of the computer system/device 302 may include the computer usable storage medium (or said program storage device). The processor 326 may represent one or more processors. The memory device 320 and/or the memory device 330 may represent one or more computer readable hardware storage devices and/or one or more memories.

The IoT peripheral 334 represents one or more devices for monitoring and measuring task focus parameters, and/or the environmental parameters. For instance in the example described hereinbefore, the IoT device was selected as a built-in video camera on the desktop work computer of the project manager engaged in the task. Many off-the-shelf software applications are well known and available to monitor and measure a user's eye movements and body movements using visual data received by the built-in camera on her desktop computer. In this case, the built-in computer camera is used as the focus sensor for sensing both the eye movements (i.e. eye focus parameter) and the body movements (i.e. body movement parameter) of the project manager.

The built-in camera device on most computing devices can be used to analyze any visually perceptible parameters of the user, such as eye movements, physical movements, facial expressions, head movements, body posture, blinking of eyes, and closing of eyes of the person engaged in the task. The camera could also be used as a visual sensor to detect a number of pages turned of reading material opened on the computing device, or to detect a number of other applications opened on the computing device.

Similar sensors and related applications for connecting the sensors to a computing device are available for computers and mobile devices such as smart phones and tablets. For instance, an eReader can be used to track changes in reading rate by monitoring how fast each page is being turned. Microphones can be used to track noise and overall sound volumes. Feeds from electronic devices can act as sensors for both focus and environmental parameters by identifying open webpages, typing speed on a keyboard, open conferences, computer games, global positioning systems, and programs monitoring weather conditions.

A multitude of sound sensors (for measuring environment ambient sound) and associated computer programs and mobile applications for cell phones are commercially available. One example provides a simple way to measure and monitor audio volumes in an environment. The app would show the approximate ambient decibel (dB) level, also known as Sound Pressure Level (SPL). The sound can be measured and monitored with a smart phone. Any other external microphone could be connected to the computing device as well.

Other more accurate sound meters or sensors is can measure and monitor sound levels and record records using a USB interface for easy setup and data download from a computing device. Such systems are available which meet ANSI and IEC 61672 Class 2 standards with a 1.4 dB accuracy and manual or automatic programmed start methods.

Ambient temperature can be measured and monitored, for instance, by a heat sensor such as a resistance temperature detector (RTD) which is a temperature sensor with a resistor that changes its resistive value simultaneously with temperature changes to provide accuracy, repeatability and stability in ambient temperature measurements.

The present invention as described herein discloses a process for supporting, deploying and/or integrating computer infrastructure, integrating, hosting, maintaining, and deploying computer-readable code into the computer system 302, wherein the code in combination with the computer system 302 is capable of implementing the methods of the present invention.

While FIG. 3 shows the computer system/device 302 as a particular configuration of hardware and software, any configuration of hardware and software, as would be known to a person of ordinary skill in the art, may be utilized for the purposes stated supra in conjunction with the particular computer system 302 of FIG. 3. For example, the memory devices 320 and 330 may be portions of a single memory device rather than separate memory devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block or step of the flowchart illustrations and/or block diagrams, and combinations of blocks/steps in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block or step in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of analyzing focus of a person engaged in a task, said method comprising:
(A) receiving, by a computing device, configuration data including identification of a task, baseline measurements of focus parameters related to a corresponding attention score of the person engaged in the task, and baseline measurements of environmental parameters of the environment where the person is performing the task;
(B) receiving from focus sensors and analyzing, by the computing device, focus parameter data captured by the focus sensors to measure and monitor the focus parameters of the person engaged in the task;
(C) receiving from environmental sensors and analyzing, by the computing device, environmental parameter data captured by the environmental sensors to measure and monitor the environmental parameters impacting the person engaged in the task;
(D) detecting, by the computing device in response to a change in the focus parameter data received from the focus sensors, cognitive degradation of the person engaged in the task and, in response, lowering the attention score and storing in the computing device the lowered attention score, the changed focus parameter data and corresponding environmental parameter data;
(E) detecting, by the computing device in response to a change in the focus parameter data received from the focus sensors, cognitive elevation of the person engaged in the task and, in response, elevating the attention score and storing in the computing device the elevated attention score, the changed focus parameter data and corresponding environmental parameter data; and
(F) repeating steps (B) through (E) until receiving, by the computing device, a task pause or task completion signal.

2. The method of claim 1, further comprising:
determining and listing, by the computing device, the focus parameter data and related environmental parameter data and attention scores of the person engaged in the task;
determining by the computing device, optimal focus parameter data and related environmental parameter data corresponding to an optimal elevated attention score for the person engaged in the task;
outputting, by the computing device, in response to changed focus parameter data or changed environmental parameter data, the listing of focus parameter data and related environmental parameter data and attention scores of the person engaged in the task; and
adjusting the baseline environmental parameter to be equal to the optimal attention score for a next iteration of the task.

3. The method of claim 1, further comprising: receiving, by the computing device, second configuration data including identification of a different task, and baseline measurements of focus parameters related to a corresponding attention score of the person engaged in the different task, wherein steps (B) through (E) are repeated for the different task.

4. The method of claim 1 further comprising:
detecting, by the computing device, a number of pages turned of reading material opened on the computing device being used by the person engaged in the task; and
detecting, by the computing device, a number of applications opened on the computing device.

5. The method of claim 1, wherein the focus parameters comprise:
eye movements of the person engaged in the task;
physical movements of the person engaged in the task;
facial expressions of the person engaged in the task;
head movements of the person engaged in the task;
body posture of the person engaged in the task;
blinking of eyes of the person engaged in the task;
closing of eyes of the person engaged in the task;
a number of pages turned of reading material opened on the computing device being used by the person engaged in the task; and
a number of applications opened on the computing device.

6. The method of claim 1, wherein the environmental parameters of the person engaged in the task comprise: ambient air temperature; ambient sound level; lighting; smells; and vibrations.

7. The method of claim 1, further comprising: comparing, by the computing device, the changed attention score to a predetermined threshold value, and outputting an alert to the person engaged in the task when the changed attention score surpasses the predetermined threshold value.

8. A computer program product, comprising one or more computer readable hardware storage devices having computer readable program code stored therein, said program code containing instructions executable by one or more processors of a computer system to implement a method of analyzing focus of a person engaged in a task, said method comprising:
(A) receiving, by a computing device, configuration data including identification of a task, baseline measurements of focus parameters related to a corresponding attention score of the person engaged in the task, and baseline measurements of environmental parameters of the environment where the person is performing the task;
(B) receiving from focus sensors and analyzing, by the computing device, focus parameter data captured by the focus sensors to measure and monitor the focus parameters of the person engaged in the task;
(C) receiving from environmental sensors and analyzing, by the computing device, environmental parameter data captured by the environmental sensors to measure and monitor the environmental parameters impacting the person engaged in the task;
(D) detecting, by the computing device in response to a change in the focus parameter data received from the focus sensors, cognitive degradation of the person engaged in the task and, in response, lowering the attention score and storing in the computing device the lowered attention score, the changed focus parameter data and corresponding environmental parameter data;
(E) detecting, by the computing device in response to a change in the focus parameter data received from the focus sensors, cognitive elevation of the person engaged in the task and, in response, elevating the attention score and storing in the computing device the elevated attention score, the changed focus parameter data and corresponding environmental parameter data; and
(F) repeating steps (B) through (E) until receiving, by the computing device, a task pause or task completion signal.

9. The computer program product of claim 8, said method further comprising:
determining and listing, by the computing device, the focus parameter data and related environmental parameter data and attention scores of the person engaged in the task;
determining by the computing device, optimal focus parameter data and related environmental parameter data corresponding to an optimal elevated attention score for the person engaged in the task; and
outputting, by the computing device, in response to changed focus parameter data or changed environmental parameter data, the listing of focus parameter data and related environmental parameter data and attention scores of the person engaged in the task; and
adjusting the baseline environmental parameter to be equal to the optimal attention score for a next iteration of the task.

10. The computer program product of claim 8, said method further comprising:
receiving, by the computing device, second configuration data including identification of a different task, and baseline measurements of focus parameters related to a corresponding attention score of the person engaged in the different task, wherein steps (B) through (E) are repeated for the different task.

11. The computer program product of claim 8, said method further comprising:
detecting, by the computing device, a number of pages turned of reading material opened on the computing device being used by the person engaged in the task; and
detecting, by the computing device, a number of applications opened on the computing device.

12. The computer program product of claim 8, wherein the focus parameters comprise:
eye movements of the person engaged in the task;
physical movements of the person engaged in the task;
facial expressions of the person engaged in the task;
head movements of the person engaged in the task;
body posture of the person engaged in the task;
blinking of eyes of the person engaged in the task; and
closing of eyes of the person engaged in the task.

13. The computer program product of claim 8, wherein the environmental parameters of the person engaged in the task comprise: ambient air temperature; ambient sound level; lighting; smells; and vibrations.

14. The computer program product of claim 8, said method further comprising: comparing, by the computing device, the changed attention score to a predetermined threshold value, and outputting an alert to the person engaged in the task when the changed attention score surpasses the predetermined threshold value.

15. A computer system, comprising one or more processors, one or more memories, and one or more computer readable hardware storage devices, said one or more hardware storage device containing program code executable by the one or more processors via the one or more memories to implement a method of analyzing focus of a person engaged in a task, said method comprising:
(A) receiving, by a computing device, configuration data including identification of a task, baseline measurements of focus parameters related to a corresponding attention score of the person engaged in the task, and baseline measurements of environmental parameters of the environment where the person is performing the task;
(B) receiving from focus sensors and analyzing, by the computing device, focus parameter data captured by the focus sensors to measure and monitor the focus parameters of the person engaged in the task;
(C) receiving from environmental sensors and analyzing, by the computing device, environmental parameter data captured by the environmental sensors to measure and monitor the environmental parameters impacting the person engaged in the task;
(D) detecting, by the computing device in response to a change in the focus parameter data received from the focus sensors, cognitive degradation of the person engaged in the task and, in response, lowering the attention score and storing in the computing device the lowered attention score, the changed focus parameter data and corresponding environmental parameter data;
(E) detecting, by the computing device in response to a change in the focus parameter data received from the focus sensors, cognitive elevation of the person engaged in the task and, in response, elevating the attention score and storing in the computing device the elevated attention score, the changed focus parameter data and corresponding environmental parameter data; and
(F) repeating steps (B) through (E) until receiving, by the computing device, a task pause or task completion signal.

16. The computer system of claim 15, said method further comprising:
determining and listing, by the computing device, the focus parameter data and related environmental parameter data and attention scores of the person engaged in the task;
determining by the computing device, optimal focus parameter data and related environmental parameter data corresponding to an optimal elevated attention score for the person engaged in the task;
outputting, by the computing device, in response to changed focus parameter data or changed environmental parameter data, the listing of focus parameter data and related environmental parameter data and attention scores of the person engaged in the task; and
adjusting the baseline environmental parameter to be equal to the optimal attention score for a next iteration of the task.

17. The computer system of claim 15, said method further comprising:
receiving, by the computing device, second configuration data including identification of a different task, and baseline measurements of focus parameters related to a corresponding attention score of the person engaged in the different task, wherein steps (B) through (E) are repeated for the different task.

18. The computer system of claim 15, aid method further comprising:
detecting, by the computing device, a number of pages turned of reading material opened on the computing device being used by the person engaged in the task; and
detecting, by the computing device, a number of applications opened on the computing device.

19. The computer system of claim 15, wherein the focus parameters comprise:
eye movements of the person engaged in the task;
physical movements of the person engaged in the task;
facial expressions of the person engaged in the task;
head movements of the person engaged in the task;
body posture of the person engaged in the task;
blinking of eyes of the person engaged in the task; and
closing of eyes of the person engaged in the task.

20. The computer system of claim 15, wherein the environmental parameters of the person engaged in the task comprise: ambient air temperature; ambient sound level; lighting; smells; and vibrations.
